(19) United States
(12) Patent Application Publication
(10) Pub. No.: US 2017/0211963 A1
(43) Pub. Date: Jul. 27, 2017

(54) METHODS AND SYSTEM FOR DETERMINING PULSE TEMPORAL COORDINATES OVERLAPPING PULSES IN A REFLECTED RADAR SIGNAL

(71) Applicants: Omid TAHERI, Edmonton (CA); Mohammad Reza Ghafouri FARD, Edmonton (CA); Pedram MOUSAVI, Edmonton (CA)

(72) Inventors: Omid TAHERI, Edmonton (CA); Mohammad Reza Ghafouri FARD, Edmonton (CA); Pedram MOUSAVI, Edmonton (CA)

(21) Appl. No.: 15/328,429

(22) PCT Filed: Jul. 21, 2015
(86) PCT No.: PCT/CA2015/000439

§ 371 Date: Jan. 23, 2017

Related U.S. Application Data
(60) Provisional application No. 62/026,913, filed on Jul. 21, 2014.

(51) Int. Cl. G01F 23/284; G01S 7/292; G01S 7/40

(52) U.S. Cl. CPC G01F 23/284; G01S 7/4021; G01S 7/292; G01S 13/0209

(57) ABSTRACT

The method of determining actual first pulse and second pulse temporal coordinates in a measured reflected signal generally comprises the steps of: identifying a combined pulse in the reflected signal; generating a first reference pulse corresponding to an expected configuration of the first pulse if the first pulse has a reference located at a first possible first pulse temporal coordinate; generating a second reference pulse corresponding to an expected configuration of the second pulse if the second pulse has a reference located at a first possible second pulse temporal coordinate; comparing the first and second reference pulses to the combined pulse; repeating the steps of generating for at least one other possible combination of first pulse and second pulse temporal coordinates and comparing these other reference pulses to the combined pulse; and determining the actual first pulse and second pulse temporal coordinates based on said repeated comparisons.

### FIELD

The improvements generally relate to the field of measurements using a radar pulse and more particularly to the field of measuring a thickness of a thin layer of dielectric material with such techniques.

### BACKGROUND

Techniques involving radio detection and ranging, i.e. radars, can be used to determine a parameter of a layer of liquid. When a radar pulse is propagated, for instance, perpendicularly through two superposed layers of liquids in a reservoir, one can measure a reflected radar signal generally including artefacts due to reflections occurring inside the reservoir. While some of these artefacts are undesirable, others can be used to characterize the two layers of liquids. Indeed, the reflected radar signal may include a first pulse due to the reflection between air and a first one of the two layers of liquids and a second pulse due to the reflection between the first one and a second one of the two layers of liquids. As long as the layer of liquid is thick enough so that the first pulse and the second pulse do not overlap one with the other, a thickness between the two interfaces can be determined based on a temporal separation (time-of-flight calculation) between the first and second pulses.

When the layer of liquid is thin so that the first pulse overlaps with the second pulse, the afore-mentioned method met limited success. Although increasing the resolution of the radar pulses by reducing their temporal width can be perceived as an avenue to address these issues, hardware and physics limitations tend to limit just how much one can increase the resolution of radar pulses. Henceforth, although such time-of-flight techniques were satisfactory to a certain degree, there remained room for improvement, particularly in terms of addressing the inherent challenges in applying such techniques to a thin layer of dielectric material.

### SUMMARY

There is provided a method of distinguishing two overlapping pulses in a reflected radar signal resulting from reflection against a thin layer of a dielectric material. In examples provided in this specification, the thin layer of dielectric material is a liquid, and the determined temporal locations of the overlapping pulses are used to measure a parameter of the thin layer of the liquid, such as permittivity or thickness. The method can include determining a combination of possible coordinates which minimizes a residual signal energy of the combined pulse. The residual signal energy may be defined as the subtraction of the first and second signal patterns having the determined coordinates from the reflected radar signal.

In accordance with one aspect, there is provided a method of determining a combination of actual first pulse and second pulse temporal coordinates in a reflected radar signal, the method comprising: measuring the reflected radar signal using a radar antenna, the reflected radar signal resulting from reflection of radiated electromagnetic energy against a thin layer of a first substance superposed to a layer of a second substance; identifying a combined pulse having a first pulse overlapping a second pulse in the reflected radar signal; generating a first reference pulse corresponding to an expected configuration of the first pulse if the first pulse has a reference point located at a first possible first pulse temporal coordinate; generating a second reference pulse corresponding to an expected configuration of the second pulse if the second pulse has a reference point located at a first possible second pulse temporal coordinate; comparing the first and second reference pulses to the combined pulse; repeating the steps of generating a first reference pulse and generating a second reference pulse for at least one other possible combination of first pulse and second pulse temporal coordinates and comparing these other reference pulses to the combined pulse; and determining a combination of actual first pulse and second pulse temporal coordinates based on said repeated comparisons.

In accordance with another aspect, there is provided a method for determining actual pulse temporal coordinates of a first pulse and of a second pulse overlapping one another in a reflected radar signal, the method comprising the steps of: measuring the reflected radar signal using a radar antenna, the reflected radar signal resulting from reflections of a radar pulse of radiated electromagnetic energy emitted by the radar antenna and propagated through the plurality of dielectric material layers, the first pulse being associated to a reflection of the radar pulse at a first interface between a first dielectric material layer and a second dielectric material layer of the plurality of dielectric material layers; and the second pulse being associated to the reflection of the radar pulse at a second interface between the second dielectric material layer and a third dielectric material layer of the plurality of dielectric material layers; in the reflected radar signal, identifying a temporal coordinate associated with a first maximum value being indicative of a first pulse and determining a first array of possible pulse temporal coordinates surrounding the temporal coordinate of the first maximum value; obtaining a plurality of possible first pulses, each one of the plurality of possible first pulses corresponding to an expected configuration of the first pulse if the first pulse has a reference point located at a corresponding one of the possible pulse temporal coordinates of the first array; obtaining a plurality of first residual signals by comparing each one of the plurality of potential first pulses from the reflected radar signal; for each one of the plurality of first residual signals, identifying a temporal coordinate associated with a second maximum value being indicative of a second pulse and determining a second array of possible pulse temporal coordinates surrounding the temporal coordinate of the second maximum value; obtaining a plurality of possible second pulses, each one of the plurality of possible second pulses corresponding to an expected configuration of the second pulse if the second pulse has a reference point located at a corresponding one of the possible pulse temporal coordinates of the second array; and obtaining a plurality of second residual signals by comparing each one of the plurality of possible second pulses from the one of the plurality of first residual signals; calculating a residual signal energy for each one of the plurality of second residual signals; and determining an actual pulse temporal coordinate of the first pulse and an actual pulse temporal coordinate of the second pulse based on possible pulse temporal coordinates which minimize the residual signal energy.

In accordance with another aspect, there is provided a system for determining a combination of actual first pulse and second pulse temporal coordinates in a reflected radar signal, the system comprising: a tank for containing at least a thin layer of a first substance; at least one radar antenna mounted to the tank, the at least one radar antenna adapted to emit a radar pulse towards the thin layer of the first substance and to detect the reflected radar signal resulting from reflection of electromagnetic energy against the thin layer of the first substance; a computing device operatively coupled to the at least one radar antenna, the computing device comprising a data processor and a medium containing machine-readable instructions executable by the data processor and configured to cause the data processor to effect the steps of: identifying a combined pulse having a first pulse overlapping a second pulse in the reflected radar signal; generating a first reference pulse corresponding to an expected configuration of the first pulse if the first pulse has a reference point located at a first possible first pulse temporal coordinate; generating a second reference pulse corresponding to an expected configuration of the second pulse if the second pulse has a reference point located at a first possible second pulse temporal coordinate; comparing the first and second reference pulses to the combined pulse; repeating the steps of generating a first reference pulse and generating a second reference pulse for at least another possible combination of first pulse and second pulse temporal coordinates and comparing these other reference pulses to the combined pulse; and determining a combination of actual first pulse and second pulse temporal coordinates based on said repeated comparisons; wherein the computing device has a display adapted to output at least the combination of actual first pulse and second pulse temporal coordinates.

The definition of the terms “pulse” and “pulse pattern” are to be interpreted in a broad manner which encompasses at least a “raw pulse” identifiable in a measured reflected radar signal (raw and/or exempt of any signal processing) and a “correlated pulse” identifiable in a reflected radar signal that would be correlated (or convoluted) with another signal.

The definition of the term “parameter” is to be interpreted in a broad manner which encompasses at least a “thickness parameter” and a “dielectric parameter”. Accordingly, a thickness of the thin layer and measurable dielectric properties of the thin layer along with measurable dielectric properties of the layer of dielectric material underneath the thin layer, if any, can be considered “parameters”.

The definition of the term “multilayer system” is to be interpreted in a broad manner which encompasses at a layer of a first substance and a layer of a second substance. Accordingly, the first substance of the multilayer system can be air through which the radar signal is propagated from the antenna and the second substance of the multilayer system can be the substance of interest. Alternatively, the first substance of the multilayer system can be the substance of interest while the second layer of the multilayer system can be another layer of dielectric material or a layer of reflective material, such as metal, for instance. Moreover, the substances are interpreted to be provided either in liquid or in solid form.

Many further features and combinations thereof concerning the present improvements will appear to those skilled in the art following a reading of the instant disclosure.

### DESCRIPTION OF THE FIGURES

In the figures,

FIG. 1 is a schematic view of an example of a system for measuring a thickness of a liquid layer;

FIG. 2 is a flow chart of a first example of a method for measuring a thickness of a liquid layer;

FIG. 3 is a block diagram of an example of a method for determining a combination of actual first pulse and second pulse temporal coordinates in a reflected radar signal;

FIG. 4A is a graph of an example of a reflected radar signal;

FIG. 4B is a graph of an example of a first residual signal;

FIG. 4C is a graph of an example of a second residual signal;

FIG. 5A is a graph of an example of a calibration pulse;

FIG. 5B is a graph of an example of a reflected radar signal;

FIG. 5C is a graph of an example of the reflected radar signal of FIG. 5B cross correlated with the calibration pulse of FIG. 5A;

FIG. 6A is a graph of an example of a pulse;

FIG. 6B is a graph of an autocorrelation of the pulse of FIG. 6A;

FIG. 7A is a graph showing an example of two overlapping pulses;

FIG. 7B is a graph showing the two overlapping pulses of FIG. 7A cross correlated with the calibration pulse of FIG. 5A;

FIG. 8A is a graph showing an example of two overlapping pulses having a white Gaussian noise added thereto;

FIG. 8B is a graph showing the two overlapping pulses of FIG. 8A cross correlated with the calibration pulse of FIG. 5A;

FIG. 9 is a photograph of a first experimental multilayer system;

FIG. 10 is a photograph of a second experimental multilayer system;

FIG. 11 is a schematic side view of an example of an antenna element;

FIG. 12 is a flowchart illustrating an exemplary calculation method for evaluating one or more properties of a multilayer system in a tank;

FIG. 13 is a flowchart illustrating an exemplary calculation method associated with the method of FIG. 12 and performed using a processor of the apparatus of FIG. 1; and

FIGS. 14A and B form a flowchart illustrating an exemplary calculation method for evaluating one or more properties of a two-layer system in a tank.

### DETAILED DESCRIPTION

The methods and system disclosed herein may be used in mobile tank gauging and/or stationary tank gauging applications. For example, the methods and system disclosed herein may be used in aviation, chemical, oil & gas, refined fuels and used oil applications for level gauging of substances in reservoirs/tanks such as, for example, aviation fuels, liquid chemicals and used oils. In various embodiments, the system and methods disclosed herein may be useful for measuring a level of a thin layer of a substance superposed to one or more than one other(s) layer(s) of substance(s) defining a multilayer system. For example, such multilayer system may comprise a first substance (layer) over a second substance (layer) in a storage tank where the first substance has a different dielectric permittivity than the second substance. Such first and second substances may, for example, comprise liquids of different densities.

Liquid level measurement using antenna pulsed radar can be used with a wide range of frequencies to determine the distance between the liquid layers and the antenna. This type of measurement requires a relatively simple time-of-flight calculation and a comparison with some pulse reference. However, circumstances arise where the time-of-flight calculation is problematic due to overlapping pulses. Indeed, when the first substance has a small thickness (relative to the temporal width of the radar pulses), reflected radar pulses may overlap one with another. Therefore, as disclosed herein, the calculation of a thickness of a thin layer of a liquid may provide a valuable improvement in the functionality of existing pulsed radar liquid level measurement systems by expanding the range of applications for which such pulsed radar systems can be used.

In various embodiments, system and methods described herein may use the same or similar data typically acquired with a pulsed radar system to characterise multi-layer systems including, for example, calculating the dielectric constants (or dielectric permittivities) and levels of the substances forming such systems. In some embodiments, some modifications may be made to the antennas and/or other installation precautions may be taken to reduce the amount and effects of spurious reflections (i.e., false echoes and/or artifacts) of the radiated electromagnetic energy associated with the use of such systems inside tanks. In various embodiments, the determination of the dielectric parameters and levels may be made with or without the advance knowledge of the total tank height or the total height of the multilayer system.

Aspects of various embodiments are described through reference to the drawings.

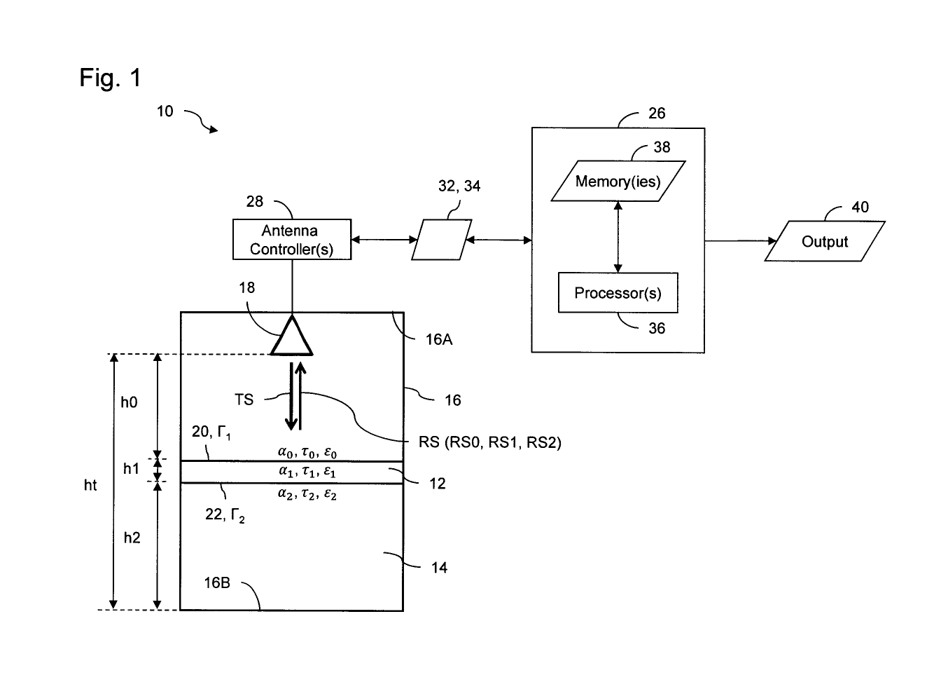

FIG. 1 is a schematic representation of a system 10 for measuring a thickness h1 of a first substance 12 (or thin layer thereof). The system 10 may further be used to measure a first dielectric permittivity of the first substance 12, and also measure a second dielectric permittivity of a second substance 14 of a multilayer system in tank 16, for instance. The tank 16 may comprise a mobile storage tank and/or a stationary storage tank. The first substance 12 and the second substance 14 may comprise liquids having different densities so as to form stacked or superposed inhomogeneous layers inside tank 16. For example, in a two-layer system stored inside tank 16, a first substance 12 (e.g., oil) may have a lower density than a second substance 14 (e.g., sludge, water) so that the first substance 12 may form an upper layer of the two-layer system and the second substance 14 may form a lower layer of the two-layer system.

The system 10 may comprise one or more antenna(e) 18 (referred hereinafter as “antenna 18”). The antenna 18 may be configured to transmit a signal (referred hereinafter as “transmitted radar signal TS”) comprising radiated electromagnetic energy toward the multilayer system (e.g., substances 12, 14) inside of the tank 16. The antenna 18 may also be configured to detect radiated electromagnetic energy (referred hereinafter as “reflected radar signal RS”) reflected from the multi-layered system (e.g., substances 12, 14). Reflected radar signal RS may comprise a combination of a plurality of signal components (e.g., patterns associated to pulses) identified herein as reflected radar signals RS0, RS1 and RS2. The reflected radar signal RS0 may comprise a first reflected radar signal representative of radiated electromagnetic energy reflected from the first substance 12 at a first interface 20 and detected using the antenna 18. The reflected radar signal RS1 may comprise a second reflected radar signal representative of radiated electromagnetic energy reflected from the second substance 14 at a second interface 22 and detected using the antenna 18. The reflected radar signal RS2 may comprise a third reflected radar signal representative of radiated electromagnetic energy reflected from the bottom 16B of tank 16 and detected using the antenna 18.

As shown in FIG. 1, the transmit and receive functions may be carried out using a single antenna 18. However, in some embodiments, separate transmit and receive antennas may be used instead of a single antenna. As explained further below, the antenna 18 may comprise one or more transmitting elements and one or more receiving elements respectively. Alternatively, the antenna 18 may comprise one or more antenna elements that are used for both transmitting and receiving. Moreover, the antenna can be disposed near the top 16A of the tank 16 or underneath the top 16A of the tank 16, as illustrated in FIG. 1.

The system 10 may also comprise one or more computing devices or computers (referred hereinafter as “computing device 26”) operatively coupled to the antenna 18. For example, the computing device 26 may be coupled to the antenna 18 via one or more antenna controllers 28. The antenna controller(s) 28 may comprise circuitry configured to drive the antenna 18 to output a transmitted signal TS in accordance with instructions 32 received from the computing device 26. The instructions 32 may comprise one or more signals representative of a desired waveform, amplitude, frequency and duration for transmitted signal TS, and can be associated to an emitted pulse. The antenna controller(s) 28 may also comprise circuitry configured to convert reflected radar signal RS (i.e., RS0, RS1, RS2) into suitable form as input 34 for the computing device 26.

The computing device 26 may comprise one or more data processors 36 (referred hereinafter as “processor 36”) and one or more associated memories 38 (referred hereinafter as “memory 38”). The computing device 26 may comprise one or more digital computer(s) or other data processors and related accessories. The processor 36 may include suitably programmed or programmable logic circuits. The memory 38 may comprise any storage means (e.g. devices) suitable for retrievably storing machine-readable instructions executable by the processor 36. The memory 38 may comprise non-transitory computer readable medium. For example, the memory 38 may include erasable programmable read only memory (EPROM) and/or flash memory. The memory 38 may comprise, for example, but is not limited to, an electronic, magnetic, optical, electromagnetic, infrared, or semiconductor system, apparatus or device. Such machine-readable instructions stored in the memory 38 may cause the processor 36 to execute functions associated with various methods disclosed herein or part(s) thereof. The execution of such methods may result in the computing device 26 producing output 40. The output 40 may comprise data representative of one or more characteristics of the multilayer system. For example, the output 40 may comprise data representative of one or more levels h0, h1, h2; one or more dielectric parameters ∈1, ∈2; temporal coordinates τ0, τ1, and τ2 and/or one or more dielectric loss tangents tan δ1, tan δ2 associated with the substances 12, 14 of the multilayer system. The output 40 may be directed to a display (not shown) or a printer so that the associated data may be presented to a user. Such display may be part of the system 10 or located remotely from the system 10. For example, the output 40 may be transmitted via wireless or wired connection to another terminal (not shown) located remotely from the system 10 and/or the tank 16.

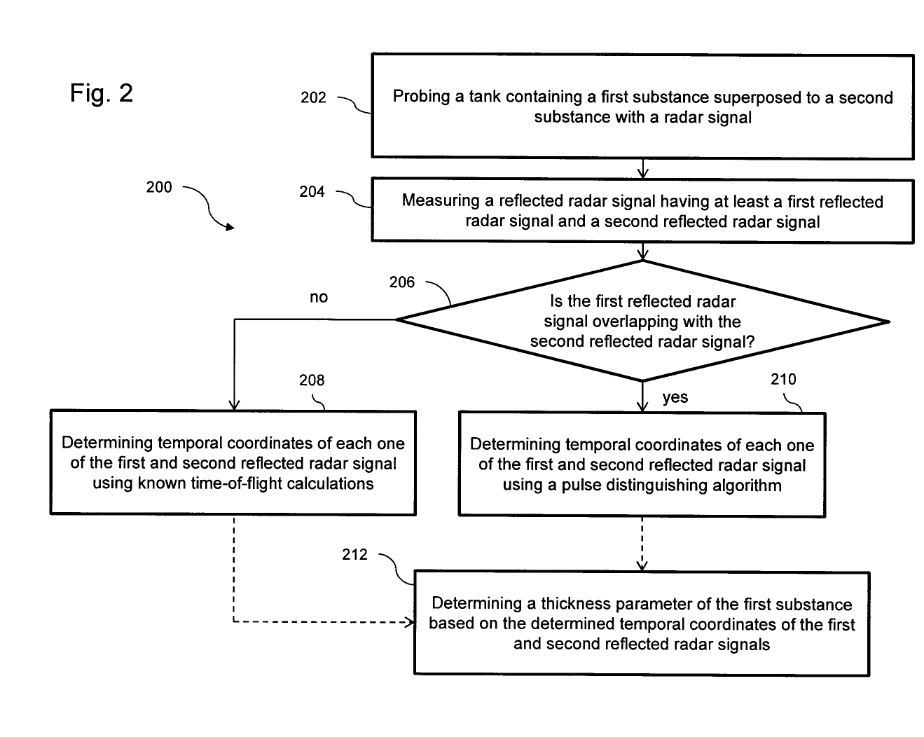

FIG. 2 is a flow chart illustrating an exemplary method 200 for measuring a thickness h1 of a first substance 12 in the multilayer system in tank 16. The first substance 12 may have a different dielectric permittivity than the second substance 14. As shown in FIG. 1, the second substance 14 may be disposed between the first substance 12 and the bottom wall 16B of the tank 16. Method 200 or part(s) thereof may be performed using the system 10. As mentioned above, the system 10 may be used to measure characteristics of a multilayer system such as layered liquids stored in tank 16. Such characteristics may include respective levels of the multiple substances and also some dielectric properties of the substances.

Referring to the method 200 of FIG. 2, it is understood that upon detecting the reflected radar signals RS0, RS1 and RS2, the computing device 26 is adapted to identify whether if the first pulse RS0 overlaps the second pulse RS1 in the reflected radar signal RS. As mentioned above, if there is no overlapping between the first pulse RS0 and the second pulse RS1, then the simple time-of-flight calculations can enable the determination of the thickness of the first substance 12. However, if there is overlapping between the first pulse RS0 and the second pulse RS1, the methods and system as disclosed herein may be used. As previously mentioned, the first pulse RS0 can overlap with the second RS1 when the layer of the first substance 12 is thin relatively to the temporal width of the radar pulses TS.

In various embodiments, the method 200 may comprise: probing a tank 16 containing a first substance 12 superposed to a second substance 14 with a transmitted radar signal TS (see block 202); measuring a reflected radar signal RS having at least a first reflected radar signal RS0 and a second reflected radar signal RS1 (see block 204); determining if the first reflected radar signal RS0 overlaps with the second reflected radar signal RS1 (see block 206); determining temporal coordinates of each one of the first and second reflected radar signals RS0, RS1 using known time-of-flight calculations if the first and second reflected radar signals RS0, RS1 do not overlap (see block 208); determining temporal coordinates of each one of the first and second reflected radar signals RS0, RS1 using a pulse distinguishing algorithm if the first and second reflected radar signals RS0, RS1 do overlap one with the other (see block 210); and, optionally (dashed line), determining a thickness of the first substance 12 based on the determined temporal coordinates of the first and second reflected radar signals RS0, RS1 (see block 212).

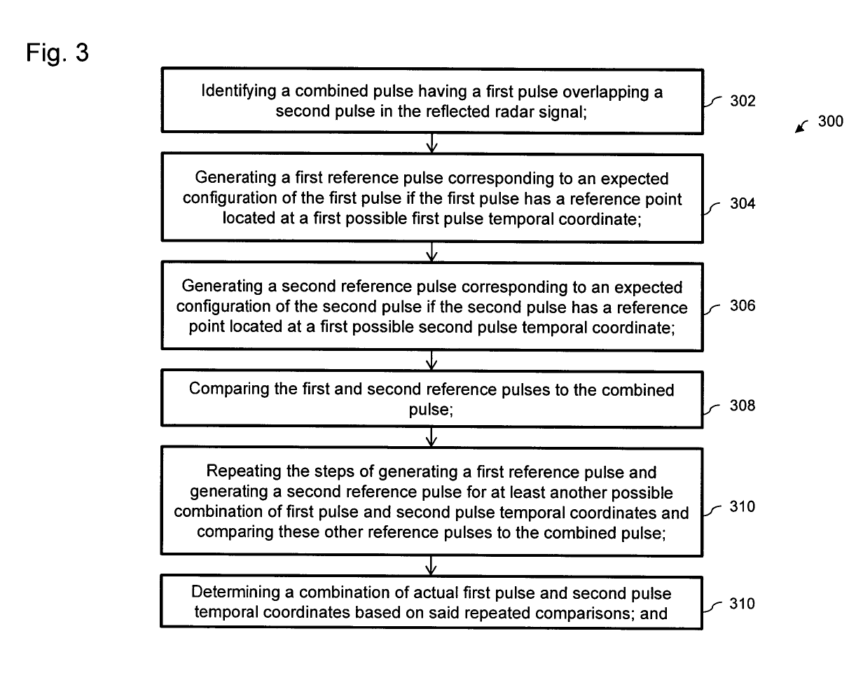

FIG. 3 is a flow chart illustrating an exemplary pulse (or pulse pattern) distinguishing algorithm (referred hereinafter as “algorithm”) 300 for determining a combination of actual first pulse and second pulse temporal coordinates based on said repeated comparisons. In an optional further step, the method can use the determined temporal coordinates to measure thickness h1 of a first substance 12 in the multilayer system in tank 16. The first substance 12 may have a different dielectric permittivity than the second substance 14. In various embodiments, the method 300 may comprise: identifying a combined pulse having a first pulse overlapping a second pulse in the reflected radar signal RS (see block 302); generating a first reference pulse corresponding to an expected configuration of the first pulse if the first pulse has a reference point located at a first possible first pulse temporal coordinate (see block 304); generating a second reference pulse corresponding to an expected configuration of the second pulse if the second pulse has a reference point located at a first possible second pulse temporal coordinate (see block 306); comparing the first and second reference pulses to the combined pulse (see block 308); repeating the steps of generating a first reference pulse and generating a second reference pulse for at least another possible combination of first pulse and second pulse temporal coordinates and comparing these other reference pulses to the combined pulse (see block 310); and determining a combination of actual first pulse and second pulse temporal coordinates based on said repeated comparisons (see block 312). It is contemplated that either one of the first pulse and the second pulse of the algorithm can be the first reflected radar signal RS0, and the other one be the second reflected radar signal RS1.

In another embodiment, the method 300 further has a step of determining the thickness h1 of the thin layer of the first substance 12 based at least on the combination of the actual first pulse and second pulse temporal coordinates determined from said repeated comparisons.

The pulse distinguishing algorithm can be processed by the computing device 26 using radar measurements of the first substance 12 superposed to the layer of the second substance 14 with the system 10, for instance. In other words, the algorithm performs a step of identifying, in the reflected radar signal RS; a combined pulse indicative of a first pulse RS0 overlapping a second pulse RS1. The combined pulse can be identified, for instance, when a pulse of the reflected radar signal RS has a width which is above a threshold. The threshold can be set to a portion of a temporal width of a calibration pulse that would be transmitted by the antenna 18, e.g. the threshold can be set to half of the width of the calibration pulse. Once the combined pulse is identified, the algorithm generates a first and a second reference pulses, at a first combination of possible respective temporal coordinates, which are then compared to the reflected radar signal. Then, the algorithm generates another combination of possible first and second reference pulse temporal coordinates and compares the other combination to the reflected radar signal. Typically, this operation will be repeated for a plurality of possible combinations of possible first and second reference pulse temporal coordinates. Based on these comparisons, the algorithm determines which one of the combinations more suitably ‘fits’ the combined pulse. The first and second possible reference pulse temporal coordinates of the combination leading to the best ‘fit’ with the combined pulse can then be estimated to being the ‘actual’ first and second reference pulse coordinates. In one embodiment, the different combinations of possible temporal coordinates are generated initially, and then ‘tried’ one after the other against the combined pulse. In another embodiment, the different combinations of possible temporal coordinates can be generated iteratively based on the results of the previous comparisons, until a satisfactory solution is found, to name one example. It is contemplated that the temporal coordinates are associated to a given reference point of the pulses and can be the same point on all the expected configurations of the first and second pulses. In other words, the temporal coordinate of the first pulse may refer be a center point of the first pulse while the temporal coordinate of the second may refer to a corresponding center point of the second pulse; both of which can be compared to center points of the reference pulses. Other reference points such as a maximum point of an envelope of the pulse, a starting point or an ending point, for instance may also be used as reference points when found satisfactory in view of specific embodiments.

In this exemplary algorithm, the first reference pulse corresponds to an expected configuration of the first pulse, say RS0, if the first pulse RS0 has a reference point located at a first possible first pulse temporal coordinate and the second reference pulse corresponds to an expected configuration of the second pulse, say RS1, if the second pulse RS1 has a reference point located at a first possible second pulse temporal coordinate. In other words, at least one of the reference pulses has a varying temporal coordinate in successive combinations. The expected configuration of the reference pulses can be based on a theoretical simulation involving known parameters of the system 10, e.g. radiation properties of the antenna 18, for instance. Alternatively, the expected configuration can be based on a radar signal which is emitted by the antenna 18 and then reflected from a reflective plate (not shown). In an embodiment, the step of comparing the first and second reference pulses to the reflected radar signal is performed by subtracting the first and second reference pulses from the reflected radar signal RS. Then, a remainder of the reflected radar signal is indicative of a residual energy. When the residual energy of the remainder of the reflected radar signal is minimized, the first and second reference pulses may be considered to fit with the corresponding one of the first and second pulse. Afterwards, the thickness h1 of the first substance 12 in the multilayer system in tank 16 can be determined based on the determined actual values.

In some embodiments, the possible combination of the first pulse and second pulse temporal coordinates can be based on previous repeated comparisons while in some other embodiments, the possible combinations of first pulse and second pulse temporal coordinates can be predetermined based on the combined pulse.

In some other embodiments, first and second amplitudes of, respectively, the first and second pulse can be determined. More specifically, the expected configuration of the first reference pulse may have a first possible first pulse amplitude and the expected configuration of the second reference pulse may have a first possible second pulse amplitude. The repeated comparisons can thus be based on at least another possible combination of first pulse amplitude and second pulse amplitudes so that the algorithm may determine a combination of actual first and second pulse amplitudes.

In some other embodiments, the algorithm may be used to determine a first dielectric permittivity of the thin layer of the first substance based at least on the actual first pulse amplitude. Moreover, the algorithm can be adapted to determine a second dielectric permittivity of the layer of the second substance based on the first dielectric permittivity of the thin layer of the first substance, the actual first and second pulse amplitudes. As known in the art, the first and second dielectric permitivitties can be determined using electromagnetism equations. For instance, a first reflection coefficient Γ₁ for the reflection at the interface 20 and a second reflection coefficient Γ₂ for the reflection at the interface 22 can be given by:

$$\begin{matrix}{Γ}_{1} = \frac{1 - \sqrt{{ɛ}_{1} / {ɛ}_{0}}}{1 + \sqrt{{ɛ}_{1} / {ɛ}_{0}}} ; and & Equation IA \\ {Γ}_{2} = \frac{1 - \sqrt{{ɛ}_{2} / {ɛ}_{1}}}{1 + \sqrt{{ɛ}_{2} / {ɛ}_{1}}} . & Equation IIA\end{matrix}$$

As these reflection coefficients can be used as a two-unknowns two-equations solvable set of equations to determine the first dielectric permittivity and the second dielectric permittivity, and thus, the thickness associated with the determined temporal location of the two overlapping pulses, some other calculation methods described herebelow can be used also.

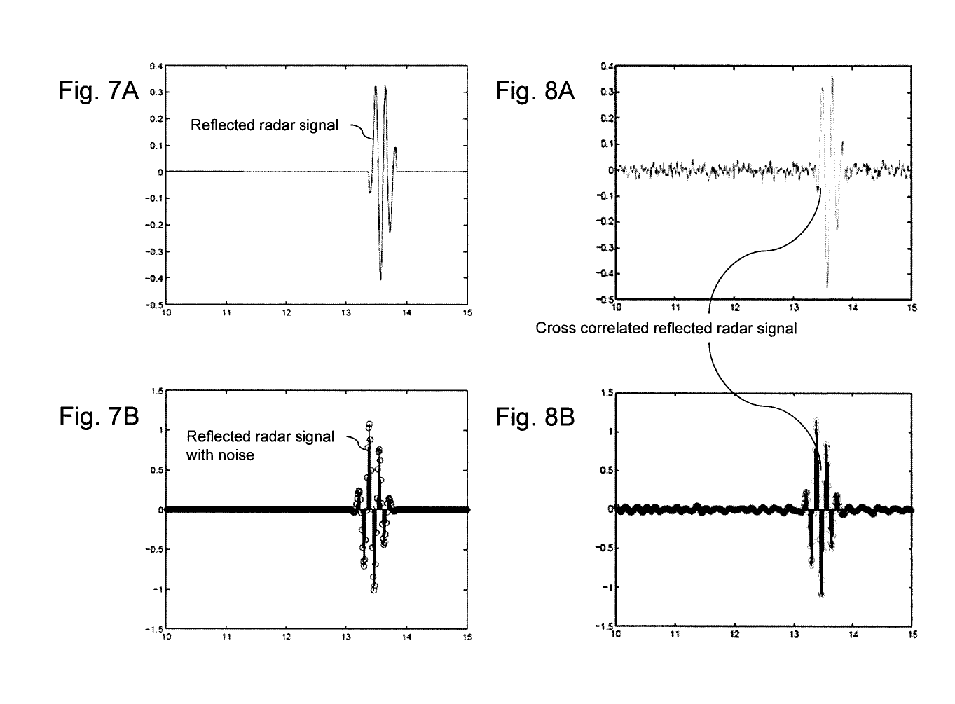

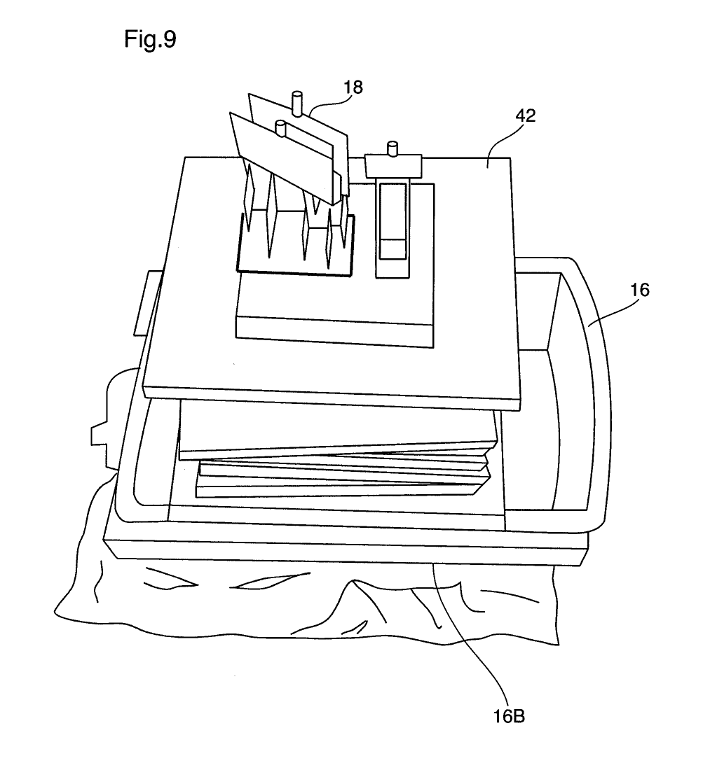

In one embodiment, the raw pulses of the reflected radar signal can be cross correlated with an associated one of the first and the second reference pulses and both the first and second reference pulses can be auto correlated with themselves prior to the steps of comparing. These steps of correlation are known in the art and can be advantageous in some circumstances. For instance, the correlation can help reducing noise effects, as illustrated in FIG. 7A to FIG. 8B. It is understood that the term “correlation” may include a “convolution” or any other suitable mathematical operations, for instance.

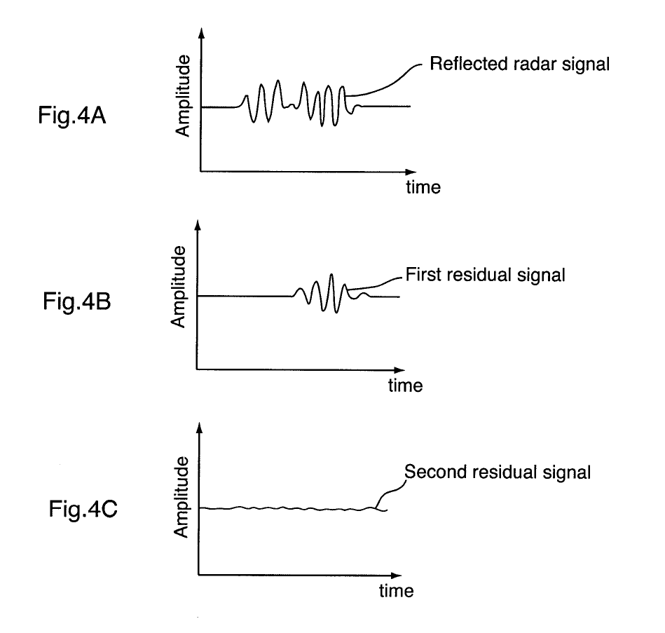

In some embodiments, the algorithm can include: in the reflected radar signal (see FIG. 4A), identifying a temporal coordinate associated with a first maximum value being indicative of a first pulse (the first pulse can either be RS0 or RS1) and determining a first array of possible pulse temporal coordinates surrounding the temporal coordinate of the first maximum value; obtaining a plurality of possible first pulses, each one of the plurality of possible first pulses corresponding to an expected configuration of the first pulse if the first pulse has a reference point located at a corresponding one of the possible pulse temporal coordinates of the first array; obtaining a plurality of first residual signals by comparing each one of the plurality of potential first pulses from the reflected radar signal (see FIG. 4B); for each one of the plurality of first residual signals, i) identifying a temporal coordinate associated with a second maximum value being indicative of a second pulse (when the first pulse is RS0, the second pulse is RS1 and vice-versa) and ii) determining a second array of possible pulse temporal coordinates surrounding the temporal coordinate of the second maximum value; obtaining a plurality of possible second pulses, each one of the plurality of possible second pulses corresponding to an expected configuration of the second pulse if the second pulse has a reference point located at a corresponding one of the possible pulse temporal coordinates of the second array; and obtaining a plurality of second residual signals by comparing each one of the plurality of possible second pulses from the one of the plurality of first residual signals; calculating a residual signal energy for each one of the plurality of second residual signals (see FIG. 4C); determining an actual pulse temporal coordinate of the first pulse and an actual pulse temporal coordinate of the second pulse based on possible pulse temporal coordinates which minimize the residual signal energy; and determining the thickness of the second dielectric material layer based at least on the difference between the actual pulse temporal coordinates of the first and second pulses.

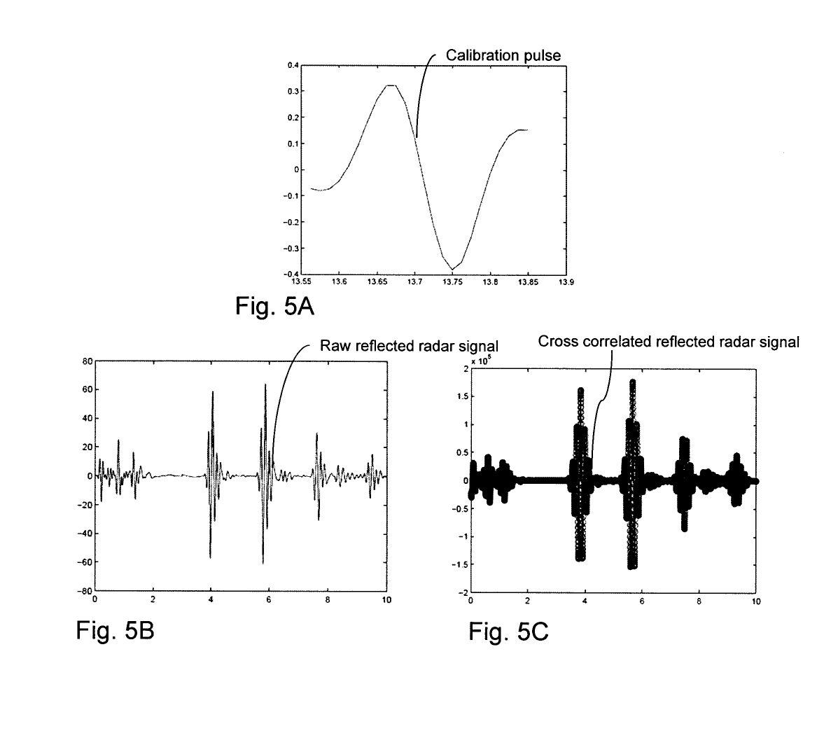

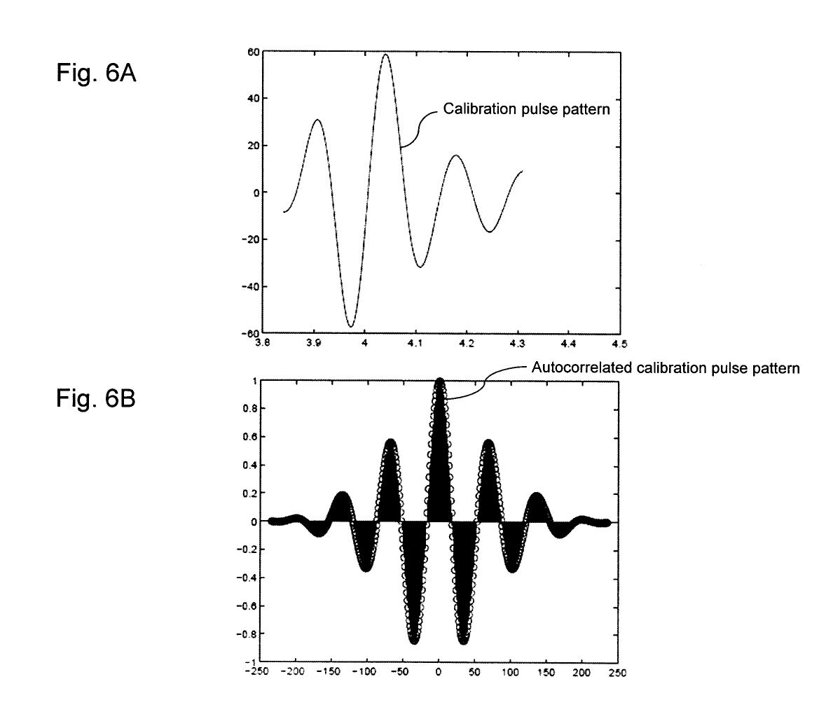

As mentioned above, correlations are generally used in communication system design. Therefore, it may be suitable to incorporate such correlation in the methods and system disclosed herein. In an embodiment described herein, it was found useful to apply correlations in the pulse distinguishing algorithm in order to find the amplitudes and the temporal coordinates of the first and second pulses. Accordingly, the reflected radar signal may be cross correlated with a calibration pulse (obtained by a metal calibration process, for instance) indicative of a shape of the reflected pulses. Further, the expected configurations of the first and second pulses can be auto correlated with themselves prior to said step of comparing with the cross correlated reflected radar signal. FIG. 5A shows a graph of an example of a calibration pulse generated with a Picosecond model 10070A Programmable Pulse Generator in conjunction with two Picosecond 5210 and 5208 impulse forming networks (IFNs). FIG. 5B shows a graph of an example of a reflected radar signal having two raw pulses associated to associated surfaces of a layer of a substance. FIG. 5C shows a graph of an example of a cross correlation between the calibration pulse of FIG. 5A with the reflected radar signal of FIG. 5B. The cross-correlated signal includes two correlated pulses associated to the surfaces of the thin layer. Depending on the application, the raw pulses or the correlated pulses can be used as the ‘pulses’ in the algorithm. In cases where correlations are used, using these correlations, it is assumed that the pulses reflected at the first interface 20 and at the second interface 22 are scaled versions of the calibration pulse. Since the reflected pulses are scaled versions of the calibration pulse, the cross correlation of the reflected pulses with the calibration pulse is likely to be a scaled version of an autocorrelation of the pulse calibration pattern, which may be referred to as “correlation pattern” hereinbelow. For example, FIG. 6A shows a graph of an example of a calibration pulse while FIG. 6B shows an autocorrelation of the calibration pulse of FIG. 6A. It is noted that the correlations may be performed using computing devices with processing algorithms, but the correlations may also be performed using electrical components such as correlators and match filters (not shown), for instance. As defined above, the reflected radar signal shown in FIG. 4A, for instance, can be a raw reflected radar signal or a correlated reflected radar signal.

In other words, a calibration pulse along with its auto correlation are recorded. The auto correlation is calculated once and it can be performed offline and/or well before the measurements are being done. The received signal is cross correlated with the calibration pulse. Then, a maximum is identified in the cross correlation and assumed to be a candidate for the starting point of the first pulse. An interval around it is then explored as candidates as well. For each first pulse starting point an interval for second pulse starting points is formed in the same way. Residual signal energy is found for all second pulse candidates. Then the algorithm moves on to another first pulse starting point candidate and repeats itself. The amplitudes of the two pulses for every pair of starting points is calculated in an iterative manner. Assuming that we know the starting points of the two pulses, if the two pulses do not overlap the maximum value of the cross correlation is the actual amplitude of one of the pulses, then we can subtract that from the reflected radar signal and recalculate the cross correlation to find its maximum which can be the amplitude of the second pulse. When the pulses overlap, the maximum may not be the amplitude as it could be a fraction of it. That is why when a pair of starting points is chosen in every iteration, the algorithm can move from one pulse to the other. In a given iteration the maximum of cross correlation for the starting point of the first pulse is found and is added to the previous value of the first pulse amplitude. Then, the residual signal is updated, the maximum of the cross correlation at the starting point of the second pulse is added to the previous value of the second pulse amplitude. So in every iteration, the amplitudes are updated and after a set number of iterations the overall amplitudes can be found. This can be done for other pairs and the pair with minimum signal energy is chosen at the end.

A MATLAB simulation was performed using a simulated pulse shown in FIG. 5A. The simulated pulse has a width of about 300 ps and translates into 24 samples with a sampling rate of 80 GS/s. Two scaled versions of this simulated pulse, one with a first amplitude of 1 and the other one with a second amplitude of 0.6, are added one to the other with different temporal coordinates to provide a simulated reflected radar signal, as shown in FIG. 7A. The simulated reflected radar signal is then cross correlated to the simulated pulse, as shown in FIG. 7B. FIGS. 8A and 8B show the patterns, of respectively FIGS. 7A and 7B, with an additional white Gaussian noise with signal to noise ratio (SNR) of 5 dB. Tables 1 and 2 show the results of an exemplary pulse distinguishing algorithm for the simulated pulses of, respectively, FIG. 7 and FIG. 8. The “pulse separation” is the temporal separation, in picoseconds, between a first pulse and a second pulse. The column “correct times” indicates whether the algorithm converges on the known, actual first and second temporal coordinates. The “recovered amplitude” indicates a first amplitude of the first pulse and a second amplitude of the second pulse. The column “height” provides the measured thicknesses for each of the combination of pulse separation for a hypothetical dielectric constant of 3. The asterisk “*” denotes the erroneous combinations of pulse separation and recovered amplitude, i.e. where the algorithm failed to provide correct estimations of either the recovered amplitudes or the correct times. It is noticed that the algorithm provides suitable values for thin layers having a thickness above ˜1 cm for exemplary permitivitties having a value of 3.

TABLE 1
Recovered amplitudes and exactitude of the temporal coordinates for
different pulse separation for the patterns of FIGS. 7.

| Pulse separation | | Recovered | |
|---|---|---|---|
| (samples:ps) | Correct times | amplitudes | Height in cm (ε = 3) |
| 1:12.5 * | Yes | 1.2288:0.3944 | 0.11 |
| 2:25 * | No | — | 0.22 |
| 3:37.5 | Yes | 1.0001:0.5997 | 0.32 |
| 4:50 | Yes | 0.9995:0.5999 | 0.43 |
| 5:62.5 | Yes | 0.9997:0.5994 | 0.54 |
| 6:75 | Yes | 0.9902:0.5938 | 0.65 |
| 7:87.5 * | No | — | 0.76 |
| 8:100 * | No | — | 0.87 |
| 9:112.5 * | No | — | 0.97 |
| 10:125 | Yes | 0.9995:0.5999 | 1.08 |
| 11:137.5 | Yes | 1.0000:0.5995 | 1.19 |
| 12:150 | Yes | 1.0000:0.5998 | 1.30 |
| 13:162.5 | Yes | 1.0003:0.5999 | 1.41 |
| 14:175 | Yes | 1.0004:0.5999 | 1.52 |
| 15:187.5 | Yes | 1.0002:0.5990 | 1.62 |
| 16:200 | Yes | 1.0000:0.5998 | 1.73 |
| 17:212.5 | Yes | 1.0002:0.6000 | 1.84 |
| 18:225 | Yes | 1.0000:0.5999 | 1.95 |
| 19:237.5 | Yes | 1.0000:0.5998 | 2.06 |
| 20:250 | Yes | 1.0000:0.5993 | 2.17 |
| 21:262.5 | Yes | 1.0000:0.5993 | 2.27 |
| 22:275 | Yes | 1.0000:0.5997 | 2.38 |
| 23:287.5 | Yes | 1.0000:0.5999 | 2.49 |
| 24:300 | Yes | 1.0000:0.6000 | 2.60 |

TABLE 2
Recovered amplitudes and exactitude of the temporal coordinates for
different pulse separation for the patterns of FIGS. 8.

| Pulse separation | | Recovered | |
|---|---|---|---|
| (samples:ps) | Correct times | amplitudes | Height in cm (ε = 3) |
| 1:12.5 * | Yes | 1.2484:0.3667 | 0.11 |
| 2:25 * | No | — | 0.22 |
| 3:37.5 | Yes | 1.0030:0.5405 | 0.32 |
| 4:50 | Yes | 1.0027:0.5965 | 0.43 |
| 5:62.5 | Yes | 0.9579:0.5899 | 0.54 |
| 6:75 | Yes | 0.9628:0.5175 | 0.65 |
| 7:87.5 * | No | — | 0.76 |
| 8:100 * | No | — | 0.87 |
| 9:112.5 | Yes | 0.9411:0.5755 | 0.97 |
| 10:125 | Yes | 0.9950:0.5910 | 1.08 |
| 11:137.5 | Yes | 0.9905:0.5802 | 1.19 |
| 12:150 | Yes | 0.9982:0.5796 | 1.30 |
| 13:162.5 | Yes | 1.0241:0.6030 | 1.41 |
| 14:175 | Yes | 1.0046:0.5684 | 1.52 |
| 15:187.5 | Yes | 0.9892:0.5817 | 1.62 |
| 16:200 | Yes | 0.9980:0.5771 | 1.73 |
| 17:212.5 | Yes | 1.0314:0.6025 | 1.84 |
| 18:225 | Yes | 0.9798:0.5910 | 1.95 |
| 19:237.5 | Yes | 0.9818:0.5947 | 2.06 |
| 20:250 | Yes | 0.9852:0.6018 | 2.17 |
| 21:262.5 | Yes | 0.9733:0.5759 | 2.27 |
| 22:275 | Yes | 0.9668:0.6297 | 2.38 |
| 23:287.5 | Yes | 0.9850:0.5798 | 2.49 |
| 24:300 | Yes | 1.0084:0.5724 | 2.60 |

### EXAMPLES

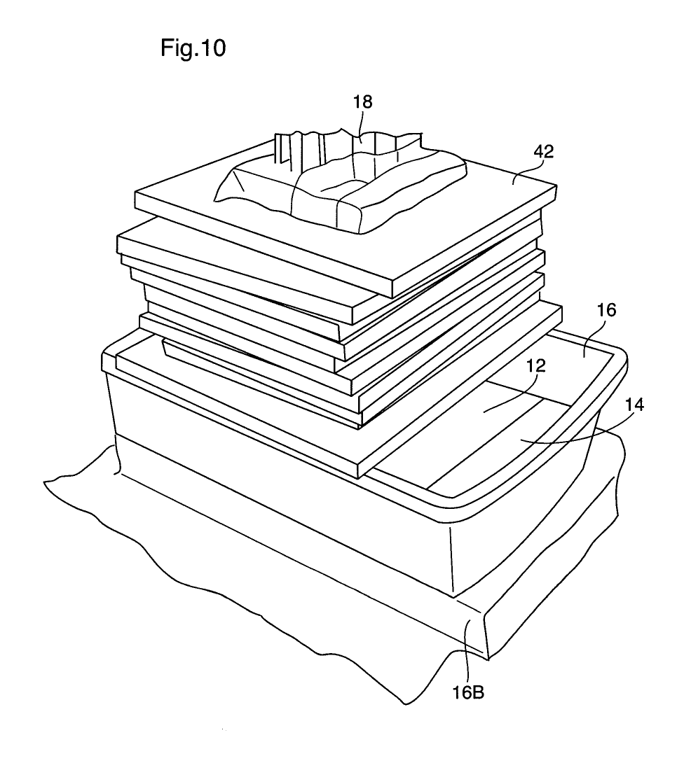

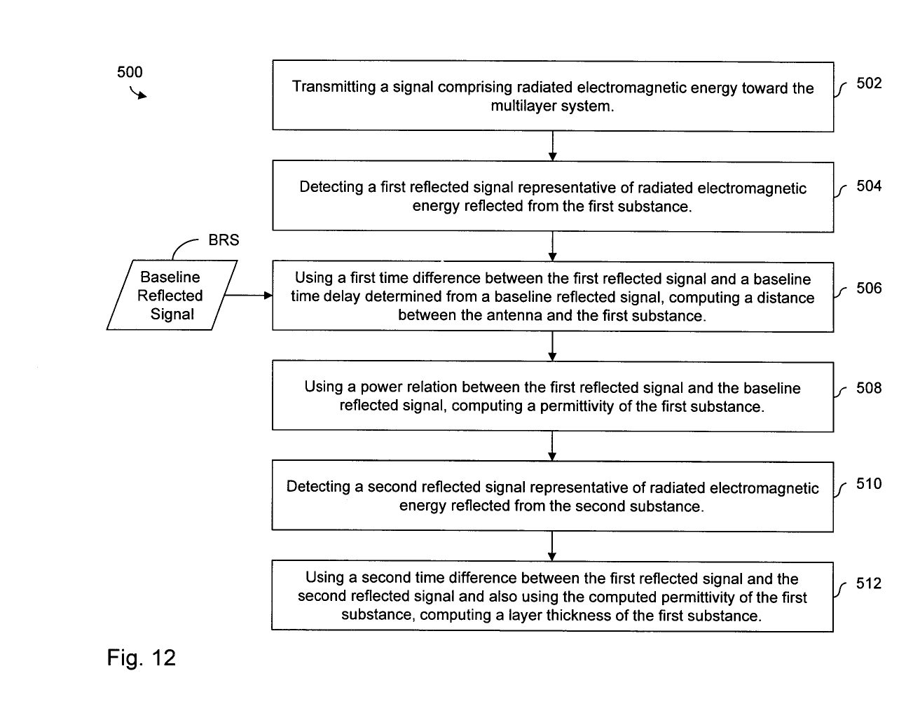

FIG. 9 shows a multilayer system disposed in a tank 16 (or bin) laying on top of an aluminum foil acting as the metal bottom 16B of the tank 16. The first substance 12 of the multilayer system was a layer of 2.9 cm, 1 cm, or 0.6 cm of canola oil while the second substance 14 was water. The antenna 18 was provided in the form of a ultra-wideband antenna array having a 8-array antenna as a transmitter and a 2-array antenna as a receiver. An exemplary antenna element 18A is shown in FIG. 11. Stacked sheets 42 of polystyrene foam sold under the trade name STYROFOAM were positioned on the tank 16 for supporting the antenna 18 above the first substance 12 and also used to adjust the height of the antenna 18 from the first substance 12. The layer of canola oil was measured to be 2.9 cm, 1 cm and 0.6 cm in the experiments.

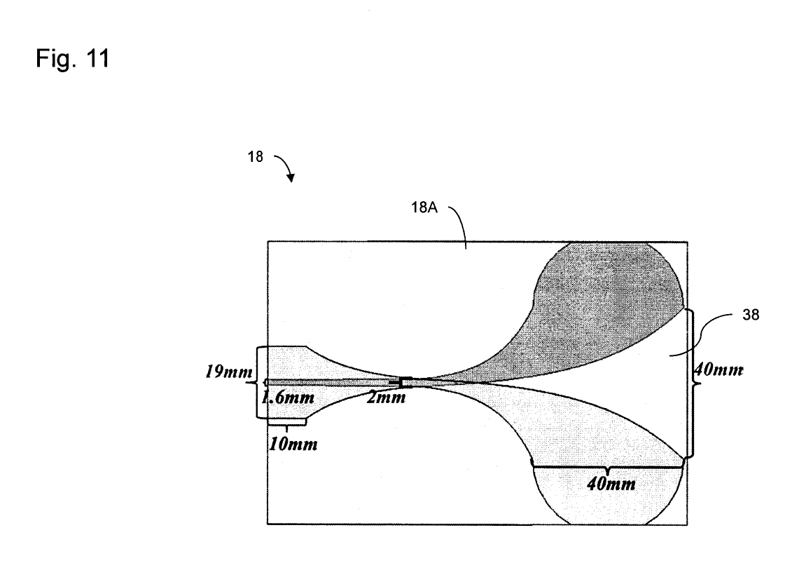

FIG. 10 shows the multilayer system of FIG. 9 with a different second substance. In this example, the second substance is composed of four slabs of marble measuring 4 cm. Experiments were performed using a pulse generator generating pulses having a temporal width of 50 ps. In the following tables, h0 denotes the distance between the tip of the antenna 18 to the surface of the first substance 12 and h1 denotes the thickness of the first substance 12. The results of the “residual energy” (integral of the second residual signals, for instance), the “starting times”, the “recovered amplitudes”, as well as the thicknesses h0 and h1 and the dielectric parameters ∈1, ∈2 are provided in Tables 3 and 4 for these exemplary experimental setups. The values in parenthesis are actual values (either known or previously measured). The asterisk “*” denotes combinations of starting times and recovered amplitudes which minimize the residual energy. It is noted that in both Tables 3 and 4, the dielectric permittivity ∈1 is not suitably estimated for h1=0.6 cm.

TABLE 3
Thicknesses h1 and dielectric parameters ε1 and ε2 for a multilayer
system where the first substance is oil and the second substance is water

| Residual energy | Starting times | Recovered amplitudes | h₀(32.1 cm) | h₁(3 cm) | ε₁(2.4) | ε₂ |
|---|---|---|---|---|---|---|
| 0.11 [symbol] 1 * | (13.6745 13.4120) | (0.1740 0.0622) | 32.06 | 2.59 | 2.32 | 6 [symbol] .8 |
| 0.1148 | (13.6745 13.3995) | (0.1740 0.0590) | 31.87 | 2.7 [symbol] | 2.21 | 64.73 |
| 0.1159 | (13.6745 13.4245) | (0.1740 0.0568) | 32.25 | 2.56 | 2.15 | 59.80 |
| Residual energy | Starting times | Recovered amplitudes | h₀(34. [symbol] cm) | h₁(1 cm) | ε₁(2.4) | ε₂ |
| 0.1315 * | (13.5995 13.5495) | (0.1728 0.0628) | 34.12 | 0.49 | 2.38 | 47.04 |
| 0.1324 | (13.5995 13.5370) | (0.1728 0.0608) | 3 [symbol] .94 | 0.62 | 2.32 | 45.81 |
| 0.1332 | (13.6120 13.5620) | (0.1392 0.1182) | 34.31 | 0.32 | 5.54 | 78.85 |
| 0.1335 | (13.5620 13.6120) | (0.1047 0.1494) | 34.31 | 0.35 | 4.46 | 70.76 |
| Residual energy | Starting times | Recovered amplitudes | h₀(34.5 cm) | h₁(0.6 cm) | ε₁(2.4) | ε₂ |
| 0.11 [symbol] * | (13.5745 13.8120) | (0.2131 0.0336) | 34.50 | 0.56 | 40.80 | 123.68 |
| 0.1186 | (13.5745 13. [symbol] 995) | (0.2131 0.029 [symbol] ) | 34.50 | 0.53 | 40.80 | 106.18 |
| 0.1206 | (13.5870 13.5370) | (0.1996 0.0 [symbol] ) | 33.94 | 0.44 | 2. [symbol] 2 | 13 [symbol] |
| 0.1228 | (13.5620 13.5995) | (0.1890 0.0975) | 34.31 | 0.12 | 21.55 | 304.96 |

[symbol]

indicates data missing or illegible when filed

TABLE 4
Thicknesses h1 and dielectric parameters ε1 and ε2 for a multilayer
system where the first substance is oil and the second substance is marble

| Residual energy | Starting times | Recovered amplitudes | h₀(27.5 cm) | h₁(3 cm) | ε₁(2.4) | ε₂ |
|---|---|---|---|---|---|---|
| 0. [symbol] * | (12.9945 13.3070) | (0.0820 0.0934) | 26.75 | 2.88 | 2.64 | 10.51 |
| 0.4051 | (12.9945 13.2945) | (0.0818 0.0928) | 26.75 | 2.77 | 2.64 | 10.28 |
| 0.4051 | (13.0070 13.3070) | (0.0811 0.0934) | 26.94 | 2.78 | 2.62 | 10.33 |
| 0.4053 | (13.0070 13.2945) | (0.0806 0.0928) | 26.94 | 2.67 | 2.60 | 10.0 [symbol] |
| Residual energy | Starting times | Recovered amplitudes | h₀(29.5 cm) | h₁(1 cm) | ε₁(2.4) | ε₂ |
| 0 [symbol] * | (13.1320 13.2320) | (0.0810 0.1021) | 28 [symbol] | 0.92 | 2.65 | 10.75 |
| (0.4323) | (13.1445 13.2320) | (0.0609 0.0545) | 29.00 | 0.91 | 2.07 | 4.18 |
| (0.4323) | (13. [symbol] 70 13.2445) | (0.0749 0.0784) | 29.19 | 0.83 | 2.47 | [symbol] 01 |
| (0.4324) | (13.1195 13.2 [symbol] 20) | (0.0658 0.0815) | 28.63 | 1.14 | 2.19 | 6.4 [symbol] |
| Residual energy | Starting times | Recovered amplitudes | h₀(30 cm) | h₁(0.5 cm) | ε₁(2.4) | ε₂ |
| [symbol] * | (13.1820 13.2 [symbol] 20) | (0.1693 0.0678) | 29.56 | 0.25 | [symbol] 20 | 28.62 |
| 0.43 [symbol] | (13.1570 13.2070) | (0.0678 0.1686) | 29.19 | 0.50 | 2.26 | 24.51 |
| 0.4381 | (13.1695 13.2195) | (0.12 [symbol] 0 0.1325) | 29.37 | 0.35 | 4.63 | [symbol] |
| 0.4382 | (13.1695 13.2070) | (0.0642 0.1686) | 29. [symbol] | 0.38 | 2.16 | 22.88 |

[symbol]

indicates data missing or illegible when filed

The algorithm outputs the actual first and second temporal coordinates of the first and second pulses (where the reference point is the starting time) and the actual first and second amplitudes of the first and second pulses (or “recovered amplitudes”). In Tables 1 and 2, the simulation scenarios presented the outputted values for a minimized residual signal energy. However, in Tables 3 and 4, other outputted values were provided for residual signal energies not necessarily being minimized. The pair with minimum signal energy is denoted with asterisks. For the setup of Table 3, estimation errors for thickness and dielectric parameters of the first substance (oil) are, respectively, 14% and 4% for h1=3 cm, while the errors are 51% and 1% for h1=1 cm. For the setup of Table 4, estimation errors for thickness and dielectric parameters of the first substance (oil) are, respectively, 4% and 10% for h1=3 cm and 8% and 10% for h1=1 cm. It is noticed that when the second substance is marble, the estimation errors tend to be lower. Perhaps this can be explained by the fact that the marble does not mix with the oil as water does, forming a transition layer for instance.

For these previous examples, a free space signal was recorded for the antenna 18. When the tank 16 is filled with material or during a metal calibration process, the free space signal is subtracted from the reflected radar signals in order to cancel out some antenna coupling.

FIG. 11 is a side view of an exemplary embodiment of the antenna 18 comprising a single antenna element 18A. The antenna 18 may comprise an ultra-wideband antenna configured to operate in the frequency range from about 3.1 GHz to about 10.6 GHz. Such frequency range may be effective in detecting reflections from multiple material layers present in the multilayer system. For the purposes of wideband pulsed radar there can be a limited number of choices that provide strong signal fidelity in the desired radiation direction, low ringing time and retain small radiated pulse width while also providing reasonable gain and constant radiation direction across the bandwidth of operation. These can include monocone, horn and Vivaldi antennas.

The non-limiting, exemplary type of antenna shown herein is a balanced antipodal Vivaldi-type antenna, but it is understood that other types of antennas could also be suitable in various applications. Such Vivaldi antennas may be produced relatively simply due to their planar configurations and may also be incorporated into arrays with relatively small overall dimensions. Non-limiting and exemplary dimensions for different parts of antenna 18 are also shown in FIG. 11. The antenna 18 of the Vivaldi type may comprise a stripline to tri-strip transmission line transition on a ROGERS 4003C (3.38 Df 0.0027@10 GHz) substrate. Flare end 38 of antenna element 18A may be curved to substantially prevent reflections or radiation that could otherwise occur from a discontinuous boundary. The width of flare end 38 of antenna 18 may be relatively wide to provide a relatively good return loss, high transient gain and radiation efficiency at the lower end of the designed frequency range (i.e., 3.1-10.6 GHz). The requirements at low frequencies are the primary concerns in designing wideband antennas for high gain, and high transient gain. In some embodiments, the overall length may be around 11 cm long to provide sufficiently continuous transitions for the lowest frequencies. In another embodiment, an array of antenna elements 18A can be used as a directional antenna (or directional sensor) which focuses the radar signal towards a direction of a pulse path. In this embodiment, undesirable reflections from internal walls of the tank 16 can be reduced in order to provide a cleaner signal to analyse with the algorithm. In specific embodiments where such a directional antenna is not available, a tank 16 having internal walls made of a non-reflective material is preferred.

As the reflection coefficients of Equations IA and IIA can be used as a two-unknowns two-equations solvable set of equations to determine the first dielectric permittivity and the second dielectric permittivity, and afterwards, the thickness associated with the determined temporal location of the two overlapping pulses and a simple time-of-flight calculation, some other calculation methods can be used also.

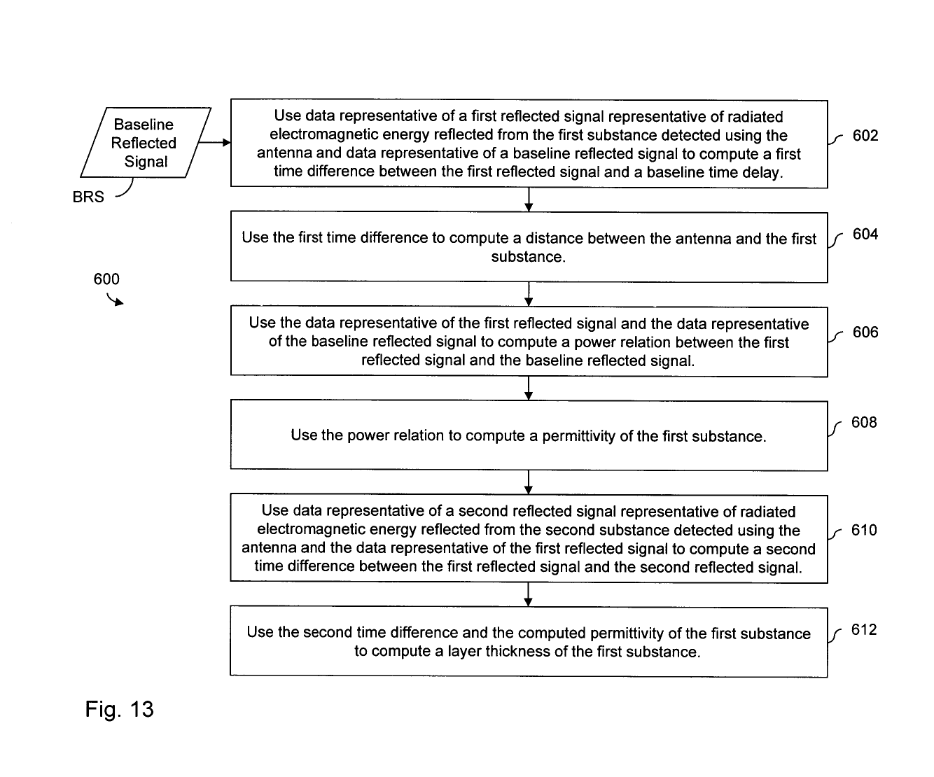

FIG. 12 is a flowchart illustrating an exemplary method 500 for evaluating one or more properties of a multilayer system including measuring thickness h1 of first substance 12 and optionally thickness h2 of second substance 14 in the multilayer system in tank 16. First substance 12 may have a different permittivity than second substance 14. As shown in FIG. 1, second substance 14 may be disposed between first substance 12 and bottom wall 16B of the tank 16. Method 500 or part(s) thereof may be performed using apparatus 10. As mentioned above, apparatus 10 may be used to evaluate properties of a multilayer system such as layered liquids stored in tank 16. Such properties may include respective thicknesses of the multiple substances and also some dielectric properties of the substances.

In various embodiments, method 500 may comprise: transmitting a signal TS comprising radiated electromagnetic energy toward the multilayer system (see block 502); detecting a first reflected signal RS0 representative of radiated electromagnetic energy reflected from first substance 12 (see block 504); using a first time difference between first reflected signal RS0 and a baseline time delay determined from a baseline reflected signal BRS, computing a distance h0 between antenna 18 and first substance 12 (see block 506); using a power relation (e.g. ratio) between first reflected signal RS0 and baseline reflected signal BRS, computing permittivity Σ₁ of first substance 12 (see block 508); detecting second reflected signal RS1 representative of radiated electromagnetic energy reflected from second substance 14 (see block 510); using a second time difference between first reflected signal RS0 and second reflected signal RS1 and also using computed permittivity ∈₁ of first substance 12, computing layer thickness h1 of first substance 12.

As explained below, in addition to thickness h1 of first substance 12, method 500 described above may be modified to evaluate thickness h2 of second substance 14 and also other properties such as dielectric properties of the multilayer system shown in FIG. 1.

In some embodiments of method 500, before acquiring reflected signal RS (e.g., RS0, RS1 and RS2) and computing properties of the multilayer system, it may be desirable to perform a calibration of apparatus 10 with or without tank 16. Such calibration may be done to take into account system characteristics of antenna 18 and tank 16. For example, a calibration may include the transmission of transmitted signal TS using antenna 18 and also the detection of baseline reflected signal BRS while tank 16 is substantially empty so that free-space data may be acquired for the purpose of obtaining system characteristics of antenna 18 together with tank 16. Free space data may comprise electromagnetic energy that is transmitted directly between a transmitting element and a detecting element of antenna 18 due to coupling and may need to be taken into account in the following computations.

As explained below, baseline reflected signal BRS may be used to characterise the baseline time delay associated with antenna 18 with respect to the distance between antenna 18 and bottom wall 16B of tank 16. Baseline time delay may comprises a time period between the transmission of the transmitted signal TS and detection of a reflected signal (from baseline reflected signal BRS) representative of radiated electromagnetic energy reflected from wall 16B of tank 16 when tank 16 is substantially empty. Baseline reflected signal BRS may also provide a baseline indication of the power reflected by bottom wall 16B of tank 16 when tank 16 is substantially empty and such value(s) may be used for later comparison for the purpose of evaluating power dissipation of electromagnetic energy into substances 12, 14 when such substances 12, 14 are present in tank 16. Baseline reflected signal BRS may also be used to identify spurious reflections (i.e., false echoes) that may be associated with the transmitted signal TS interacting with the structure of tank 16 so that such spurious reflections may be either filtered out from reflected signal RS or simply ignored during processing so that such spurious reflections may not be mistaken for reflected signals RS0, RS1 and RS2. Accordingly, baseline reflected signal BRS may be stored in memory 34 and used in subsequent measurements.

In some cases, apparatus 10 may be calibrated prior to apparatus 10 being delivered to the user and therefore without physical access to tank 16. In such circumstances, the calibration may be conducted using a (e.g., metallic) plate or sheet having similar dielectric properties as bottom wall 16B of tank 16 and also at a distance from antenna 18 similar to the distance between bottom wall 16B and antenna 18 in order to mimic the situation where antenna 18 is installed with tank 16. Accordingly, the calibration may be conducted without physical access to tank 16 but under comparable conditions. Alternatively, the calibration could be conducted using another similar tank or on site.

Memory 34 may comprise machine-readable instructions that may cause processor 32 to control the performance of such calibration(s). In such case the user may instruct computing device 22, via suitable user interface of computing device 22, to perform such calibration after installation of apparatus 10 with tank 16 and the calibration may then be carried out substantially automatically or semi-automatically by apparatus 10.

Baseline reflected signal BRS may be used to account for interference (i.e., free space data) from coupling between transmitting and receiving antennas 18 if more than one antenna 18 is used. For example, such interference may be accounted for by removing the free-space data in baseline reflected signal BRS from reflected signal RS. Specifically, baseline reflected signal BRS may be acquired with an empty or substantially empty tank 16 and may include the data taken only during the first few nanoseconds until the point where coupling and ringing has died away and ignoring the reflections that come from an empty tank 16 farther away. Alternatively, the interference due to coupling between transmitting elements and detecting elements of antenna 18 could be characterized using one or more detected signals other than baseline reflected signal BRS and not necessarily acquired in the presence of tank 16.

In the case of a single antenna element 18A that both transmits and detects, there may not be a coupling issue as referenced above. Nevertheless, a similar calibration may be required to take into account ringing and any reflections from objects near antenna element 18A.

The accumulated power reflected whether in baseline reflected signal BRS during calibration or in reflected signal RS during operation may be computed using Equation 1 below

Pₐ(t)=∫₀^{t}Γ(t)²dt Equation 1
where Γ(t) is the reflected data (i.e., BRS or RS) and Pₐ(t) is the accumulated reflected power. To reduce the amount processing requirements, the calculation of accumulated reflected power may be deferred until after the data has been filtered and only done for where the reflections of interest (i.e., RS0, RS1, RS2) have been identified in reflected signal RS.

Quantifying the noise in reflected signal (BRS or RS) may be useful for estimating the amount of power in reflected signal (BRS or RS). The noise covariance may be estimated using the reflected data (BRS or RS) in the first few nanoseconds where no reflected pulse has yet been detected or near the end where no reflected pulses would be expected. However, since the noise covariance would depend on the entire system itself, it could be characterised beforehand and stored as a single number value. The contribution of noise to the accumulated power may be quantified as the covariance of reflected amplitude or slope of the accumulated power. This contribution may be deducted from the accumulate power and multiplied by the pulse width.

In order to calculate the positions of the relevant signals RS0, RS1, and RS2 (e.g., pulses) with respect to time in reflected data RS, the derivative of the accumulated power data, or the absolute value of the reflected data RS may be median filtered using Equation 2 below

$$peak = medfilt ( \frac{d}{2 dt} {\int }_{0}^{t} {Γ ( t )}^{2} d t ) = medfilt ( \vert Γ ( t ) \vert ) \qquad Equation 2$$

and then the peaks may be located (based on maximum values and restricting to separations of one pulse width), leading to relatively accurate calculation of the reflected pulse centers. This may be used to identify reflected signals RS0, RS1 and RS2 of interest in reflected signal RS.

The determination of the permittivities may require relatively accurate prediction of the expected reflection power for different permittivities. Accordingly, the reflection amplitude with distance may be taken into account by fitting the measured reflection amplitude with distance from a metal surface (e.g., bottom wall 16B of tank 16) to an equation that takes into account the path loss behaviour and relative gain and near field characteristics of the antennas/arrays 18. The reflection amplitude with distance may be corrected with one of two equations, namely Equation 3

$${Γ}_{metal} ( r ) = ( {k}_{1} ( {e}^{- {k}_{2} {r}^{{k}_{3}}} - 1 ) + \frac{{k}_{4}}{r} ) , \qquad Equation 3$$

where kₙ are the fitting variables and r is the distance from the antenna; and Equation 4 below

$${Γ}_{metal} ( r ) = \frac{{k}_{1}}{r} + \frac{{k}_{2}}{{r}^{2}} + \frac{{k}_{3}}{{r}^{3}} + \frac{{k}_{4}}{{r}^{4}} + \frac{{k}_{5}}{{r}^{5}} + \frac{{k}_{6}}{{r}^{6}} + \frac{{k}_{7}}{{r}^{7}} , \qquad Equation 4$$

Either equation may be used since both converge to the inverse distance relation far from antenna 18. Using Equations 3 or 4, the measured amplitudes from the reflection signal RS may then be calibrated using Equation 5 below

$${Γ}_{corr} ( r ) = \frac{{A}_{meas} ( r ) {Γ}_{metal} ( {r}_{0} )}{{A}_{metal} ( {r}_{0} ) {Γ}_{metal} ( r )} , \qquad Equation 5$$

where Aₘₑₐₛ(r) is the measured reflection amplitude, Aₘₑₜₐₗ(r₀) is the measured reflection from a metal surface at some distance r₀ (pre-stored, determined from baseline reflected signal BRS). The time delay of antenna 18 may also be calculated based on the known distance of the metal surface used for the calibration pulse and the reflected pulse time from the median filtered data (again determined from baseline reflected signal BRS). Variables k₁₋₄ may characterize the antenna reflection amplitude equation.

Accordingly, the data that may be used for calibration and that may be derived from baseline reflected signal BRS and stored beforehand may include the time delay of the system (including antenna 18 and tank 16) and the reflected power expected for antenna 18 being used with tank 16. These may be characteristics of the system and may be stored in the variables contained in Equation 5.

The measured amplitude of a reflected pulse may be determined from the accumulated power data using Equation 6 below

$$A ( r ) = \sqrt{{P}_{a} ( {t}_{peak} + \frac{{t}_{width}}{2} ) - {P}_{a} ( {t}_{peak} - \frac{{t}_{width}}{2} )} \qquad Equation 6$$

where t_{width} is the width of the pulse and tₚₑₐₖ is the center of the reflected pulse.

Referring again to method 500, distance h0 between antenna 18 and first substance 12 may be computed based on the reflected time in relation to the baseline time delay associated with antenna 18 using Equation 7 below

$${h}_{0} = \frac{c}{2} ( {t}_{1} - {t}_{delay} ) , \qquad Equation 7$$

where c is the speed of light, t₁ is the time of the first pulse (i.e., first reflected signal RS0) and t_{delay} is the time delay found from the metal calibration (i.e., from baseline reflected signal BRS).

The relative permittivity ∈₁ of first substance 12 may be found based on the change in the reflected power at the location of the peak locations in reflected signal RS0 plus and minus half of the pulse width using

$$\frac{1}{\vert {η}_{1} \vert} = \frac{1}{\vert {η}_{0} \vert} \frac{1 + {Γ}_{corr}^{1} ( {h}_{0} )}{1 - {Γ}_{corr}^{1} ( {h}_{0} )} , \\ where \\ η = \frac{j ω μ}{{γ}_{i}} and {γ}_{i} = j ω \sqrt{μ {ɛ}_{0} {ɛ}_{i}^{′} ( 1 - j tan δ ) = α + j β} . \qquad Equation ( 8 )$$

It should be noted that in some of the equations herein, the real part ∈₁′ of the complex permittivity is specified for the computations.

The thickness h1 of first substance 12 may then be calculated from the difference in time to the second reflected pulse (i.e., the difference in time between first reflected signal RS0 and second reflected signal RS1) and the permittivity ∈₁ of first substance 12 using Equation 9 below

$${h}_{1} = \frac{c}{2 \sqrt{{ɛ}_{1}^{′}}} ( {t}_{2} - {t}_{1} ) , \qquad Equation 9$$

As mentioned above, method 500 may be modified to further determine thickness h2 and one or more dielectric properties of the multilayer system. For example, based on the computed permittivity ∈₁ of first substance 12, the dielectric loss tangent tan δ₁ of first substance 12 may be computed, estimated or obtained from a look-up table. Such look-up table may be stored in memory 34. Then, using dielectric loss tangent tan δ₁ of first substance 12, permittivity ∈₂ of second substance 14 may be computed using Equation 10 below, which includes variables previously defined above

$$\frac{1}{\vert {η}_{2} \vert} = \frac{1}{\vert {η}_{1} \vert} \frac{1 + \frac{1}{{T}_{12} {T}_{21}} {Γ}_{corr}^{2} ( {h}_{0} + {h}_{1} ) {e}^{- 2 {α}_{1} {h}_{1}}}{1 - \frac{1}{{T}_{12} {T}_{21}} {Γ}_{corr}^{2} ( {h}_{0} + {h}_{1} ) {e}^{- 2 {α}_{1} {h}_{1}}} , \\ where {T}_{ij} = \frac{2 {η}_{i}}{{η}_{i} + {η}_{j}} . \qquad Equation 10$$

The calculated permittivity ∈₂ of second substance 14 may be hampered by the imprecise knowledge of the dielectric loss tangent tan δ₁ of first substance 12 so it may be desirable to obtain dielectric loss tangent tan δ₁ from the look-up table based on the computed permittivity ∈₁. In some embodiments, the look-up table may also be used to identify first substance 12 based on the computed permittivity ∈₁.

Method 500 may also comprise detecting third reflected signal RS2 representative of radiated electromagnetic energy reflected from bottom wall 16B of tank 16 and using a third time difference (t₃−t₂) between second reflected signal RS1 and third reflected signal RS2 and also using the computed permittivity ∈₂ (i.e., see Equation 10) of second substance 14, computing a thickness h2 of second substance 14. Equation 11 may be used when the total height ht of tank 16 (i.e., the position of bottom wall 16B relative to antenna 18) is unknown.

$${h}_{2} = \frac{c}{2 {\sqrt{{ɛ}_{2}^{′}}}^{′}} ( {t}_{3} - {t}_{2} ) , \qquad Equation 11$$

However, if the total height ht of the tank 16 is known, method 500 may comprise using total height ht of tank 16, thickness h0 of the space between antenna 18 and first substance 12 and thickness h1 of first substance 12 to compute a layer thickness h2 of second substance 14 using Equation 12 below

h₂=hₜ−h₀−h₁, Equation 12
where hₜ is the total height of tank 16 measured from antenna 18 to bottom wall 16B as shown in FIG. 1. Accordingly, if the total height ht of tank 16 is known, Equation 12 may be used instead of Equation 11 to compute layer thickness h2 of second substance 14.

Also, if total height ht of tank 16 is known, permittivity ∈₂ could be more accurately computed using Equation 13 below

$${ɛ}_{2}^{′} = {( \frac{c}{2 {h}_{2}} ( {t}_{3} - {t}_{2} ) )}^{2} . \qquad Equation 13$$

Accordingly, method 500 may comprise detecting third reflected signal RS2 representative of radiated electromagnetic energy reflected from bottom wall 16B of tank 16; and using a third time difference (t₃−t₂) between second reflected signal RS1 and the third reflected signal RS2 and also the total height ht of tank 16, computing a permittivity ∈₂ of second substance 14. The use of Equation 13 instead of Equation 10 to compute permittivity ∈₂ could be more efficient and require less processing power.

Furthermore, the knowledge of the total height ht of tank 16 may also permit the dielectric loss tangent tan δ₁ of first substance 12 to be computed instead of obtained from the look-up table. Accordingly, method 500 may comprise using the computed permittivity ∈₁ of first substance 12, the computed permittivity ∈₂ of second substance 14, the distance h0 between antenna 18 and first substance 12, and, thickness h1 of first substance 12 to compute a dielectric loss tangent tan δ₁ of first substance 12. For example, dielectric loss tangent tan δ₁ may be computed using Equation 14 below, which contains variables previously defined above.

$${α}_{1} = - ln ( \frac{{Γ}_{corr}^{2} ( {h}_{0} + {h}_{1} )}{{T}_{12} {T}_{21} \frac{{η}_{2} - {η}_{1}}{{η}_{2} + {η}_{1}}} ) / 2 {h}_{1} \qquad Equation 14$$

The loss in the reflected power may be accounted for if the substances can be identified and its dielectric loss can be obtained from the look-up table. Alternatively, the loss in the reflected power can be computed if the reflection pulse (i.e., reflected signal RS2) of the bottom of tank 16 is detectable. For example, if third reflected signal RS2 is measurable, dielectric loss tangent tan δ₂ of second substance 14 may be computed using Equation 15 below

$${α}_{2} = - ln ( \frac{{Γ}_{corr}^{3} ( {h}_{0} + {h}_{1} + {h}_{2} )}{{e}^{- 2 {α}_{1} {h}_{1}} {T}_{12} {T}_{13} {T}_{12} {T}_{21} \frac{{η}_{3} - {η}_{2}}{{η}_{3} + {η}_{2}}} ) / 2 {h}_{2} \qquad Equation 15$$

where η₃ would be −1 and Γ_{corr}³ would be 1 if bottom wall 16B of tank 16 comprises a metallic material. Accordingly, method 500 may comprise using the computed permittivity ∈₁ of first substance 12, the computed permittivity ∈₂ of second substance 14, distance h0 between antenna 18 and first substance 12 and thickness h1 of first substance 12 and total height ht of tank 16 to compute a dielectric loss tangent tan δ₂ of second substance 14.

The equations presented above may be used in either a least squares fitting, an iterative technique and/or other known or other computational techniques on reflected signal RS that includes additional reflections (i.e., on systems having more than two layers and/or on reflected signals comprising overlapping and/or spurious reflections) using the reflected pulse shape, but could require additional data processing power and memory.

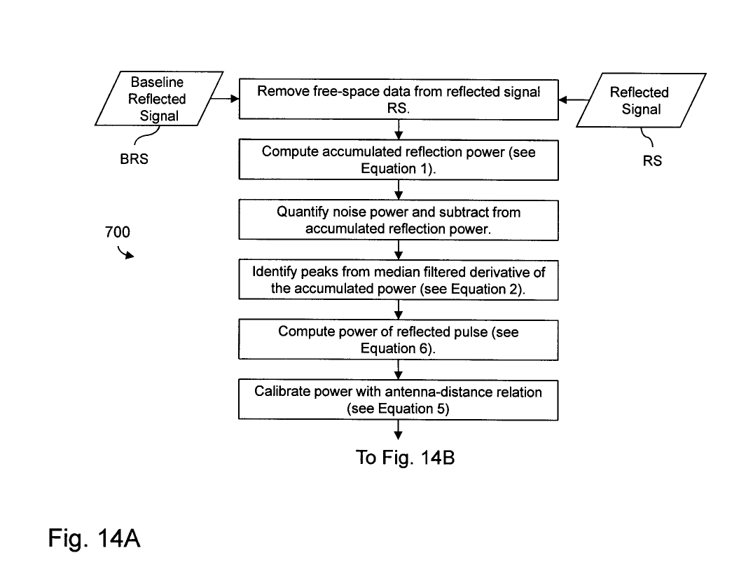

FIG. 13 is a flowchart illustrating an exemplary method 600 associated with the method 500 of FIG. 12 and performed using processor 32 of apparatus 10. As described above, apparatus 10 may be used in the performance of method 500 described above. Accordingly, method 600 comprises tasks that may be performed by processor 32 and that may be useful in the performance of method 500 or part(s) thereof. Method 600 may be performed based on machine-readable instructions that may be stored in memory 34 and executable by processor 32 and cause processor 32 to: use data representative of first reflected signal RS0 representative of radiated electromagnetic energy reflected from first substance 12 detected using antenna 18 and data representative of baseline reflected signal BRS to compute a first time difference between first reflected signal RS0 and a baseline time delay (see block 602); use the first time difference to compute distance h0 between antenna 18 and first substance 12 (see block 604); use the data representative of first reflected signal RS0 and the data representative of baseline reflected signal BRS to compute a power relation between the first reflected signal RS0 and the baseline reflected signal BRS (see block 606); use the power relation to compute a permittivity ∈₁ of the first substance 12 (see block 608); use data representative of second reflected signal RS1 representative of radiated electromagnetic energy reflected from second substance 14 detected using antenna 18 and the data representative of first reflected signal RS0 to compute a second time difference between first reflected signal RS0 and the second reflected signal RS1 (see block 610); and use the second time difference and the computed permittivity ∈₁ of first substance 12 to compute layer thickness h1 of first substance 12.

As described above, apparatus 10 may also be used to determine properties such as dielectric properties of the multilayer system and layer thickness h2 of second substance 14 in addition to layer thickness h1 of first substance. Accordingly, in some embodiments, method 600 may further comprise: obtaining a dielectric loss tangent tan δ₁ of first substance 12 based on the computed permittivity ∈₁ of first substance 12; and using the dielectric loss tangent tan δ₁ of first substance 12 to compute permittivity ∈₂ of second substance 14.

In some embodiments, method 600 may further comprise: using data representative of third reflected signal RS2 representative of radiated electromagnetic energy reflected from bottom wall 16B of tank 16; computing a third time difference between second reflected signal RS1 and third reflected signal RS2; and using the third time difference and the computed permittivity ∈₂ of second substance 14 to compute layer thickness h2 of second substance 14.

In some embodiments, method 600 may further comprise using a total height ht of tank 16, distance h0 between antenna 18 and first substance 12, and, layer thickness h1 of first substance 14 to compute layer thickness h2 of second substance 14.

In some embodiments, method 600 may further comprise: using data representative of third reflected signal RS2 representative of radiated electromagnetic energy reflected from bottom wall 16B of tank 16; computing a third time difference between second reflected signal RS1 and third reflected signal RS2; and using the third time difference and a total height ht of tank 16, computing a permittivity ∈₂ of second substance 14.

In some embodiments, method 600 may further comprise using the computed permittivity ∈₁ of first substance 12, the computed permittivity ∈₂ of second substance 14, distance h0 between antenna 18 and first substance 12 and layer thickness h1 of first substance 14 to compute a dielectric loss tangent tan δ₁ of first substance 12.

In some embodiments, method 600 may further comprise using the computed permittivity ∈₁ of first substance 12, the computed permittivity ∈₂ of second substance 14, distance h0 between antenna 18 and first substance 12, layer thickness h1 of first substance 14 and total height ht of tank 16 to compute dielectric loss tangent tan δ₂ of second substance 14.

As explained above, baseline reflected signal BRS may comprise an expected reflected signal representative of radiated electromagnetic energy reflected from bottom wall 16B of tank 16 when tank 16 is substantially empty.

As explained above, the baseline time delay may comprise a time period between the transmission of transmitted signal TS and detection of a reflected signal RS representative of radiated electromagnetic energy reflected from bottom wall 16B of tank 16 when tank 16 is substantially empty.

Various aspects of the present disclosure may be embodied as an apparatus, method or computer program product. Accordingly, aspects of the present disclosure may take the form of an entirely hardware embodiment, an entirely software embodiment or an embodiment combining software and hardware aspects. Furthermore, aspects of the present disclosure may take the form of a computer program product embodied in one or more non-transitory computer readable medium(ia) having computer readable program code (machine-readable instructions) embodied thereon. The computer program product may, for example, be executed by a computer, processor or other suitable logic circuit to cause the execution of one or more methods disclosed herein in entirety or in part. Computer program code for carrying out operations for aspects of the present disclosure may be written in any combination of one or more programming languages, including an object oriented programming language and/or conventional procedural programming languages. The program code may execute entirely or in part by processor 32 (see FIG. 1) or other computer.

In some cases, the layer thickness resolution that may be measured using the methods disclosed herein may be limited by the width of the pulse (e.g., RS0, RS1, RS2) by the relation of Equation 16 below

$${T}_{r} = \frac{c {t}_{width}}{2 \sqrt{{ɛ}_{r}}} \qquad Equation 16$$

where ∈ᵣ is the relative permittivity of the layer (e.g., first substance 12 or second substance 14). For example, with oil with a relative permittivity of 2.4 and a pulse width of 600 ps, this may amount to a resolution of 5.8 cm before the pulses begin to overlap. Additional computations may be required to resolve overlapping pulses that are due to relatively thin layer thicknesses.

Subsequent reflections from within a single layer may be greatly reduced in amplitude compared to the first reflection associated with that layer, but may nevertheless overlap with other reflections/pulses in reflected signal RS. However, the ability to detect where these reflections occur after finding height h0 and permittivity ∈₁ of first substance 12 can be relatively accurate and such subsequent pulses may be compensated for by identifying such pulses using the “peak finding” step described above (see Equation 2) and then ignoring such pulses when conducting the above computations or filtering it out.

Also, the reflections off of objects that lie directly in the path of the antenna 18 may be ignored or removed from the reflected signal RS if the locations of such objects is known and the level and permittivity of the substance(s) over it can still be accurately determined. However, if such object blocks one or more layers below it, it may not be possible, depending on the particular situation, to fully characterize those one or more layers that are obstructed by the object.

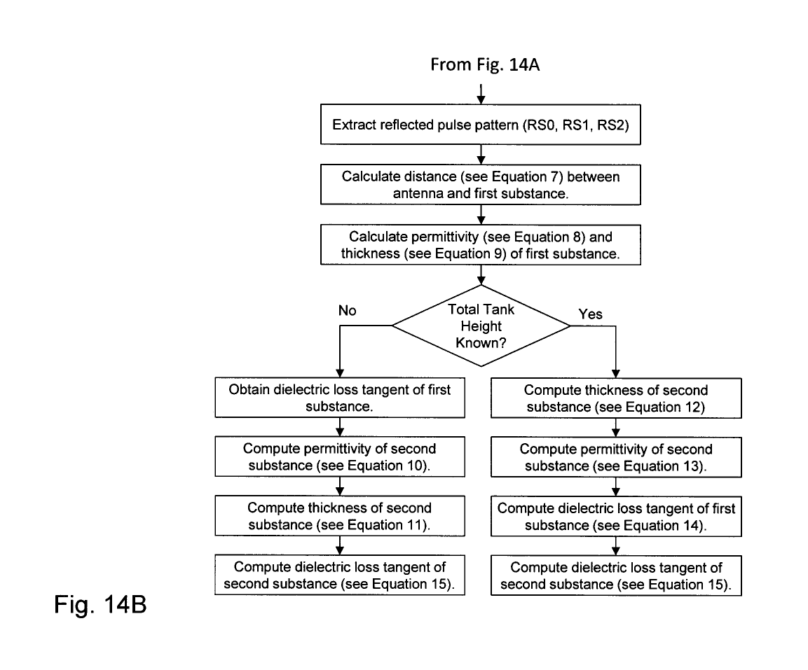

FIGS. 14A and B form a flowchart illustrating an exemplary method 700 for evaluating one or more properties of a two-layer system comprising first substance 12 and second substance 14 in tank 16. Method 700 comprises tasks previously described above and therefore the description of such tasks will not be repeated. Apparatus 10 could be used to perform method 700 or part(s) thereof. Also, various blocks of method 700 make reference to equations previously introduced above. Even though FIGS. 14A and B are specific to a two-layer system, it could be modified for multi-layer systems as demonstrated by method 800 described below.

As can be understood, the examples described above and illustrated are intended to be exemplary only. Although the algorithm is adapted for two overlapping pulses, it can be adapted for more than two pulses in some other embodiments. Moreover, in embodiments where at least one of the substances of the multilayer system is provided in a liquid form, it can be useful to wait an amount of time in order to let the liquid settle inside the tank, as sloshing can add undesirable noise in the measured reflected signal. Further, it is contemplated that the algorithm presented herein can use either the first or the second pulse of the reflected signal with no particular order of importance. The first pulse can be associated with either the first interface or the second interface and vice-versa. The scope is indicated by the appended claims.

1. A method of determining a combination of actual first pulse and second pulse temporal coordinates in a reflected radar signal, the method comprising:
measuring the reflected radar signal using a radar antenna, the reflected radar signal resulting from reflection of radiated electromagnetic energy against a thin layer of a first substance superposed to a layer of a second substance;
identifying a combined pulse having a first pulse overlapping a second pulse in the reflected radar signal;
generating a first reference pulse corresponding to an expected configuration of the first pulse if the first pulse has a reference point located at a first possible first pulse temporal coordinate;
generating a second reference pulse corresponding to an expected configuration of the second pulse if the second pulse has a reference point located at a first possible second pulse temporal coordinate;
comparing the first and second reference pulses to the combined pulse;
repeating the steps of generating a first reference pulse and generating a second reference pulse for at least one other possible combination of first pulse and second pulse temporal coordinates and comparing these other reference pulses to the combined pulse; and
determining a combination of actual first pulse and second pulse temporal coordinates based on said repeated comparisons.

2. The method of claim 1, further comprising determining the parameter of the thin layer of the first substance based at least on the combination of the actual first pulse and second pulse temporal coordinates determined from said repeated comparisons.

3. The method of claim 1, wherein the at least one other possible combination of first pulse and second pulse temporal coordinates is determined based on a previous step of comparing.

4. The method of claim 2 wherein the parameter of the thin layer is a thickness of the thin layer.

5. The method of claim 4, wherein said steps of comparing includes subtracting the first and second reference pulses from the combined pulse.

6. The method of claim 5, wherein the actual first pulse and second pulse temporal coordinates are determined based on the temporal coordinates of the first and second reference pulse combination which is associated to a minimum result from said subtraction.

7. The method of claim 2, wherein the parameter of the thin layer is a dielectric permittivity of the thin layer, wherein the expected configuration of the first reference pulse has a first possible first pulse amplitude and the expected configuration of the second reference pulse has a first possible second pulse amplitude, wherein the repeated comparisons are based on at least another possible combination of first pulse amplitude and second pulse amplitudes and wherein said determining a combination further comprises determining a combination of actual first and second pulse amplitudes.

8. The method of claim 7 further comprising determining a first dielectric permittivity of the thin layer of the first substance based at least on the actual first pulse amplitude.

9. The method of claim 8 further comprising determining a second dielectric permittivity of the layer of the second substance based on the first dielectric permittivity of the thin layer of the first substance, the actual first and second pulse amplitudes.

10. The method of claim 1, wherein the expected configurations of the first and second reference pulses are based on a calibration pulse resulting from the reflection of a radar signal onto a reflective material.

11. The method of claim 10 wherein the reflected radar signal is cross correlated with the calibration pulse and the calibration pulse is auto correlated with itself prior to the steps of comparing.

12. The method of claim 1, wherein the first substance is a liquid.

13. A method for determining actual pulse temporal coordinates of a first pulse and of a second pulse overlapping one another in a reflected radar signal, the method comprising the steps of:
measuring the reflected radar signal using a radar antenna, the reflected radar signal resulting from reflections of a radar pulse of radiated electromagnetic energy emitted by the radar antenna and propagated through the plurality of dielectric material layers, the first pulse being associated to a reflection of the radar pulse at a first interface between a first dielectric material layer and a second dielectric material layer of the plurality of dielectric material layers; and the second pulse being associated to the reflection of the radar pulse at a second interface between the second dielectric material layer and a third dielectric material layer of the plurality of dielectric material layers;
in the reflected radar signal, identifying a temporal coordinate associated with a first maximum value being indicative of a first pulse and determining a first array of possible pulse temporal coordinates surrounding the temporal coordinate of the first maximum value;
obtaining a plurality of possible first pulses, each one of the plurality of possible first pulses corresponding to an expected configuration of the first pulse if the first pulse has a reference point located at a corresponding one of the possible pulse temporal coordinates of the first array;
obtaining a plurality of first residual signals by comparing each one of the plurality of potential first pulses from the reflected radar signal;
for each one of the plurality of first residual signals,
identifying a temporal coordinate associated with a second maximum value being indicative of a second pulse and determining a second array of possible pulse temporal coordinates surrounding the temporal coordinate of the second maximum value;
obtaining a plurality of possible second pulses, each one of the plurality of possible second pulses corresponding to an expected configuration of the second pulse if the second pulse has a reference point located at a corresponding one of the possible pulse temporal coordinates of the second array; and
obtaining a plurality of second residual signals by comparing each one of the plurality of possible second pulses from the one of the plurality of first residual signals;
calculating a residual signal energy for each one of the plurality of second residual signals; and
determining an actual pulse temporal coordinate of the first pulse and an actual pulse temporal coordinate of the second pulse based on possible pulse temporal coordinates which minimize the residual signal energy.

14. The method of claim 13 further comprising determining a parameter of the second dielectric material layer based at least on the difference between the actual pulse temporal coordinates of the first and second pulses.

15. (canceled)

16. The method of claim 14, wherein the parameter of the thin layer is a dielectric permittivity of the thin layer and wherein the first and second pulses are provided in the form of the radar pulse scaled by first and second pulse amplitudes, the method further comprising determining a first dielectric permittivity of the second dielectric material layer based at least on the first pulse amplitude.

17. (canceled)

18. The method of claim 13, wherein the expected configurations of the first and second pulses are based on a calibration pulse resulting from the reflection of the radar pulse onto a reflective material.

19. The method of claim 13, wherein said steps of comparing includes subtracting the first and second pulses from the reflected radar signal.

20. The method of claim 18, wherein the reflected radar signal is cross correlated with the calibration pulse and the calibration pulse is auto correlated with itself prior to the steps of obtaining a plurality of first residual signals and obtaining a plurality of second residual signals.

21. (canceled)

22. A system for determining a combination of actual first pulse and second pulse temporal coordinates in a reflected radar signal, the system comprising:
a tank for containing at least a thin layer of a first substance;
at least one radar antenna mounted to the tank, the at least one radar antenna adapted to emit a radar pulse towards the thin layer of the first substance and to detect the reflected radar signal resulting from reflection of electromagnetic energy against the thin layer of the first substance;
a computing device operatively coupled to the at least one radar antenna, the computing device comprising a data processor and a medium containing machine-readable instructions executable by the data processor and configured to cause the data processor to effect the steps of:
identifying a combined pulse having a first pulse overlapping a second pulse in the reflected radar signal;
generating a first reference pulse corresponding to an expected configuration of the first pulse if the first pulse has a reference point located at a first possible first pulse temporal coordinate;
generating a second reference pulse corresponding to an expected configuration of the second pulse if the second pulse has a reference point located at a first possible second pulse temporal coordinate;
comparing the first and second reference pulses to the combined pulse;
repeating the steps of generating a first reference pulse and generating a second reference pulse for at least another possible combination of first pulse and second pulse temporal coordinates and comparing these other reference pulses to the combined pulse; and
determining a combination of actual first pulse and second pulse temporal coordinates based on said repeated comparisons;
wherein the computing device has a display adapted to output at least the combination of actual first pulse and second pulse temporal coordinates.

23. The system of claim 22, wherein the computing device is further adapted to effect the step of determining a parameter of the thin layer of the first substance based at least on the combination of the actual first pulse and second pulse temporal coordinates determined from said repeated comparisons, and wherein the computing device is adapted to output the parameter on the display.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)
